(19) United States
(12) Patent Application Publication
(10) Pub. No.: US 2010/0086459 A1
(43) Pub. Date: Apr. 8, 2010

(54) Impurity removing apparatus and method of operating the same

(75) Inventors: Hiroshi Ikeda, Tokyo (JP); Takashi Kyotani, Tokyo (JP); Yasuhiko Suzuki, Tokyo (JP); Masaaki Osato, Tokyo (JP)

Correspondence Address: WENDEROTH, LIND & PONACK, L.L.P., 1030 15th Street, N.W.,, Suite 400 East, Washington, DC, 20005-1503, US

(73) Assignee: Ebara Corporation

(21) Appl. No.: 12/585,924

(22) Filed: Sep. 29, 2009

(30) Foreign Application Priority Data
Oct. 3, 2008 (JP) 2008-258628

(51) Int. Cl. B01D 53/75; B01J 19/02; B01D 53/68

(52) U.S. Cl. 423/240 R; 422/211; 422/223

(57) ABSTRACT

An impurity removing apparatus is simple in structure for removing impurities from a rare gas and enable to make the rare gas reusable. The impurity removing apparatus includes a first treatment device 21 for removing fluorine and fluorine compound which are mixed with a rare gas discharged from an excimer laser oscillation apparatus 10, a second treatment device 23 for removing oxygen generated by the first treatment device, and a circulation device 25 for circulating the rare gas discharged from the excimer laser oscillation apparatus 10 and returning the rare gas to the excimer laser oscillation apparatus 10.

### BACKGROUND OF THE INVENTION

1. Field of the Invention

The present invention relates to an impurity removing apparatus for removing impurities, and more particularly to an impurity removing apparatus for removing impurities contained in a rare gas used in and discharged from an excimer laser oscillation apparatus thereby to make the rare gas reusable, and a method of operating such an impurity removing apparatus.

2. Description of the Related Art

Excimer laser apparatus are widely used as the light source of exposure (photolithographic) systems for use in semiconductor fabrication processes. The excimer laser apparatus include a laser tube filled with, e.g., a mixture of argon gas (Ar) and fluorine gas, a mixture of krypton gas (Kr) and fluorine gas, or a mixture of xenon gas (Xe) and fluorine gas. In operation, the gas mixture in the laser tube is excited, generating a laser beam by way of stimulated emission of the energy of excited gas molecules. The laser tube is also filled with a rare gas as a buffer gas, which is preferably a helium gas (He) or a neon gas (Ne).

Since the fluorine gas, which is used in the excimer laser apparatus, is extremely reactive and is excited in operation, the fluorine gas tends to react with the materials that make up the laser tube, producing various fluorine compounds (impurities) including CF₄, SiF₄, HF, NF₃, C₂F₆, etc. These impurities are undesirable because they reduce the output level of the laser beam. Consequently, there have heretofore been proposed methods of removing such impurities or methods of suppressing the generation of impurities.

For example, there has been proposed a method of removing HF by bringing HF into contact with a metal fluoride compound, a hydrogen metal fluoride compound, or a mixture of these compounds (see Japanese laid-open patent publication No. H6-275902). According to this proposed method, HF is removed without removing the excimer laser gas of F₂. According to another method disclosed in Japanese laid-open patent publication No. H6-283781, an excimer laser apparatus includes two parallel gas circulation lines. One of the gas circulation lines has a cold trap for removing SiF₄ and HF, and the other gas circulation line has a halogen trap and a cryogenic adsorption tower for removing SiF₄, HF, and CF₄. The latter gas circulation line also removes F₂. In order to minimize the removal of F₂, the former gas circulation line is normally used to remove SiF₄ and HF. Only when CF₄ needs to be removed, the latter gas circulation line is used.

### SUMMARY OF THE INVENTION

However, the proposed impurity removing methods described above need to be carried out by large-size apparatus that cannot easily be reduced in size and simplified in structure.

It is an object of the present invention to provide an impurity removing apparatus which is smaller in size and simpler in structure than the apparatus of the related art for removing impurities contained in a rare gas used in and discharged from an excimer laser oscillation apparatus thereby to make the rare gas reusable in the excimer laser oscillation apparatus. Another object of the present invention is to provide a method of operating an impurity removing apparatus which is simpler than the methods of the related art for removing impurities contained in a rare gas used in and discharged from an excimer laser oscillation apparatus thereby to make the rare gas reusable in the excimer laser oscillation apparatus.

In order to achieve the above objects, the present invention provides an impurity removing apparatus comprising: a first treatment device for removing fluorine and fluorine compound which are mixed with a rare gas discharged from an excimer laser oscillation apparatus; a second treatment device for removing oxygen generated by the first treatment device; and a circulation device for circulating the rare gas discharged from the excimer laser oscillation apparatus and returning the rare gas to the excimer laser oscillation apparatus.

With the above arrangement, a fluorine gas, which contributes to the emission of a laser beam from the excimer laser oscillation apparatus, is removed as an impurity mixed with the rare gas. However, since fluorine, fluorine compound, and oxygen that is generated when the fluorine and the fluorine compound are removed, the rare gas which is scarce and precious can be reused. The impurity removing apparatus is simpler in structure than the impurity removing apparatus of the related art and can refine the rare gas.

In a preferred aspect of the present invention, the circulation device circulates the rare gas from the excimer laser oscillation apparatus to the first treatment device, then from the first treatment device to the second treatment device, and then from the second treatment device to the excimer laser oscillation apparatus.

With the above arrangement, since fluorine and fluorine compound are removed from the rare gas in an early stage on a path of the rare gas in the impurity removing apparatus, parts of the impurity removing apparatus, which are disposed downstream of the first treatment device, are prevented from being corroded (oxidized) by F₂, HF, etc. As the impurities including F₂ mixed with the rare gas are removed and the rare gas is circulated, the rare gas is refined efficiently, and the running cost of the rare gas is lowered.

In a preferred aspect of the present invention, the second treatment device is configured to remove the oxygen with a treating agent, and is provided with a regenerating device for regenerating the treating agent to make the treating agent reusable after the treating agent has been used to remove the oxygen.

With the above arrangement, even when the treating agent housed in the second treatment device is consumed, it can be regenerated for reuse without the need for detaching the second treatment device. Moreover, the running cost of the treating agent is lowered.

In a preferred aspect of the present invention, the first treatment device comprises a device for removing fluorine and fluorine compound, and water or a PFC gas which are mixed with the rare gas.

The PFC (perfluoro compound) gas refers to a fluorine compound with a high global warming potential such as SF₆, CF₄, C₂F₆, etc.

With the above arrangement, the impurity removing apparatus can remove water from the rare gas when water is mixed with the rare gas. Furthermore, the impurity removing apparatus can remove greenhouse effect gases of SF₆, CF₄, C₂F₆, etc. which are mixed as impurities with the rare gas.

In a preferred aspect of the present invention, the impurity removing apparatus removes fluorine and fluorine compound which are contained in rare gases discharged from a plurality of excimer laser oscillation apparatus described above, and removes oxygen which is generated when the fluorine and the fluorine compound are removed.

With the above arrangement, if the rare gas is discharged from each of the excimer laser oscillation apparatus at a low rate and over a short period of time, then the impurity removing apparatus can remove impurities from rare gases discharged from the excimer laser oscillation apparatus. Consequently, the impurity removing apparatus has high impurity removal efficiency.

The present invention also provides a method of operating an impurity removing apparatus, comprising: circulating a rare gas discharged from an excimer laser oscillation apparatus which emits a laser beam; removing fluorine and fluorine compound which are mixed with the rate gas; removing oxygen which is generated when the fluorine and the fluorine compound are removed; returning the rare gas to the excimer laser oscillation apparatus; and reusing the rare gas returned to the excimer laser oscillation apparatus.

The above method removes fluorine and fluorine compound which are mixed with the rare gas discharged from the excimer laser oscillation apparatus, and also removes oxygen which is generated when the fluorine and the fluorine compound are removed. Therefore, the method is capable of allowing the rare gas to be reused.

The impurity removing apparatus according to the present invention first removes fluorine and fluorine compound mixed as impurities with the rare gas discharged from the excimer laser oscillation apparatus, and then removes oxygen which is generated when the fluorine and the fluorine compound are removed. This makes it possible to allow the rare gas to be reused and to make the apparatus small in size and simple in structure. The impurity removing apparatus circulates and reuses the rare gas for the effective utilization of the rare gas, and also lowers the running cost of the rare gas. If the treatment device for removing the oxygen is provided with the regenerating device, then the impurity removing apparatus can be operated continuously without replacing the treating agent for removing oxygen. If the impurity removing apparatus includes the treatment device for removing water or a PFC gas, then it can efficiently remove water or a PFC gas while removing fluorine, fluorine compound, and oxygen.

The method of operating the impurity removing apparatus according to the present invention efficiently removes fluorine and fluorine compound mixed as impurities with the rare gas and also removes oxygen. The method circulates and reuses the rare gas for the effective utilization of the rare gas, and also lowers the running cost of the rare gas.

The above and other objects, features, and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a block diagram of an impurity removing apparatus according to a first embodiment of the present invention;

FIG. 2 is a schematic view showing the basic structure of an excimer laser oscillation apparatus to be connected to the impurity removing apparatus;

FIG. 3 is a cross-sectional view of a second treatment tube of the impurity removing apparatus according to the first embodiment, the second treatment tube being provided with a regenerating device for regenerating a treating agent; and

FIG. 4 is a block diagram of an impurity removing apparatus according to a second embodiment of the present invention.

### DETAILED DESCRIPTION OF THE PREFERRED EMBODIMENTS

Preferred embodiments of the present invention will now be described with reference to the drawings. In figures, the same or corresponding members are given the same reference numerals and a duplicate description thereof will be omitted. The present invention is not limited to below-described embodiments.

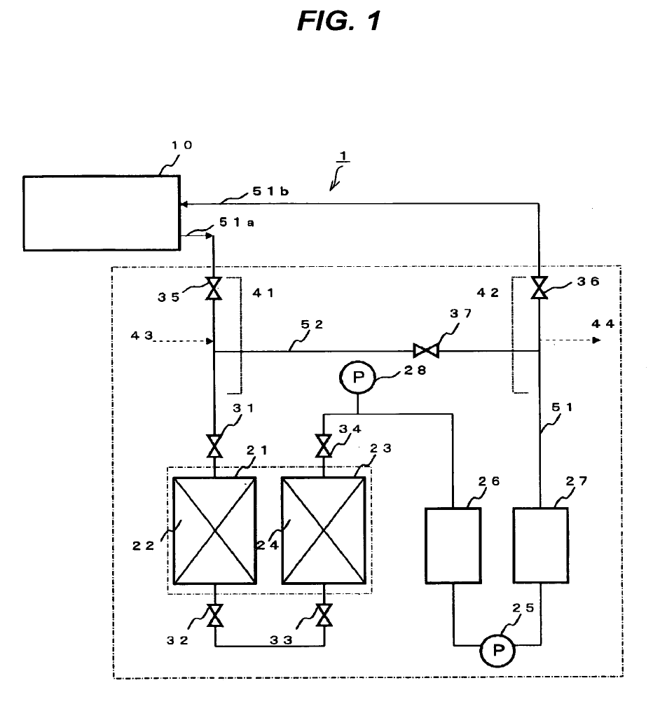

As shown in FIG. 1, an impurity removing apparatus 1 according to a first embodiment of the present invention is used while being connected to an excimer laser oscillation apparatus 10. The impurity removing apparatus 1 includes a first treatment tube (treatment device) 21 and a second treatment tube (treatment device) 23 both for removing impurities from a rare gas discharged from the excimer laser oscillation apparatus 10, a pipe 51 serving as a path along which the rare gas flows, and a circulation pump (circulation device) 25 for circulating the rare gas through a closed loop extending from and to the excimer laser oscillation apparatus 10.

In the below-described embodiments, a laser gas, which is used in the excimer laser oscillation apparatus 10 for generating a laser beam, comprises a mixture of fluorine gas and argon gas, and a buffer gas added to dilute the laser gas comprises a neon gas. Alternatively, the laser gas may comprise a mixture of fluorine gas and krypton gas or a mixture of fluorine gas and xenon gas, and the buffer gas may comprise a helium gas or any of other rare gases. The fluorine gas may be replaced with a chlorine gas.

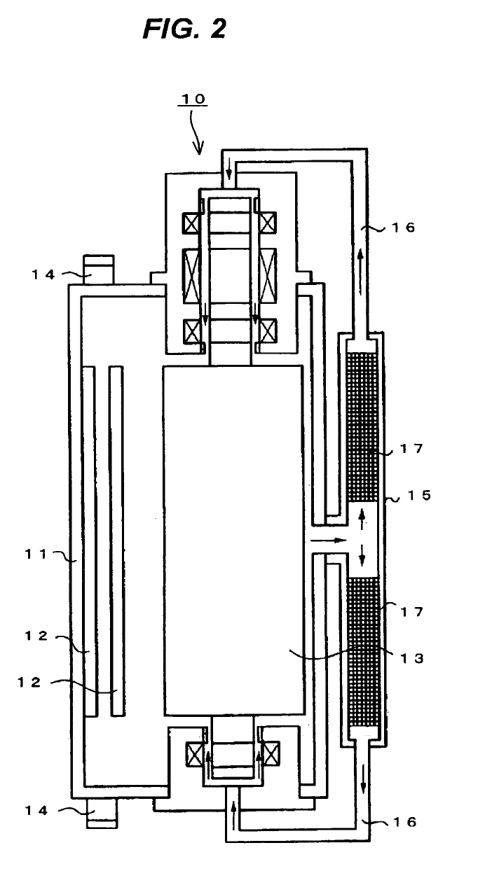

FIG. 2 schematically shows the basic structure of the excimer laser oscillation apparatus 10. As shown in FIG. 2, the excimer laser oscillation apparatus 10 has a laser vessel 11 to be filled with a laser gas, which comprises a mixture of fluorine gas and argon gas, and a buffer gas which comprises a neon gas. The laser vessel 11 houses therein a pair of main discharge electrodes 12, 12 for generating an electric discharge for oscillating a laser beam, and a circulation fan 13 for producing a high-speed laser gas flow between the main discharge electrodes 12, 12. The excimer laser oscillation apparatus 10 also has windows 14 on the laser vessel 11 for emitting the laser beam from the laser vessel 11, a gas inlet chamber 15 connected to the laser vessel 11, a pair of gas inlet pipes 16 extending from the gas inlet chamber 15 to the laser vessel 11, and a pair of dust removal filters 17 disposed in the gas inlet chamber 15.

Returning to FIG. 1, the impurity removing apparatus 1 according to the first embodiment of the present invention will now be described in detail. The impurity removing apparatus 1 has a closed loop through which the rare gas discharged from the excimer laser oscillation apparatus 10 is circulated by the circulation pump 25 back to the excimer laser oscillation apparatus 10. The rare gas discharged from the excimer laser oscillation apparatus 10 flows from a circulation flow inlet 41 into the impurity removing apparatus 1. In the impurity removing apparatus 1, the rare gas then flows through the first treatment tube 21, which serves as a first treatment device, and then through the second treatment tube 23, which serves as a second treatment device. Thereafter, the rare gas flows out of the impurity removing apparatus 1 from a circulation flow outlet 42 back into the excimer laser oscillation apparatus 10.

The first treatment tube 21 is filled with a treating agent 22 for removing fluorine, fluorine compound, and water. According to the first embodiment of the present invention, fluorine and fluorine compound as impurities mixed with the rare gas are first removed by the treating agent 22. If the rare gas contains water, the water also removed.

Fluorine (F₂) and fluorine compound (HF) are extremely highly reactive gases. If they are removed from an early stage of the closed loop in the impurity removing apparatus 1, any parts of the impurity removing apparatus 1, which are disposed downstream of the first treatment tube 21, are prevented from being corroded (oxidized) by F₂ and HF. Furthermore, since F₂ that contributes as a component of the laser gas is removed for increased fluorine compound removal efficiency and water is also removed, it is possible to make the rare gas reusable.

The treating agent 22 for removing fluorine, fluorine compound, and water should preferably comprise zeolite, a combination of zeolite and calcium oxide, or a combination of zeolite and calcium hydrate. Zeolite is effective to remove fluorine, fluorine compound, and water. If zeolite is used to remove water and calcium oxide or calcium hydrate is used to remove fluorine and fluorine compound, then the service life of zeolite is made longer than if only zeolite is used to remove fluorine, fluorine compound, and water.

As the treating agent 22 is used to remove fluorine, fluorine compound, and water, they can easily be removed with good removal efficiency. Moreover, the impurity removing apparatus 1 becomes relatively small in size and simple in structure.

The first treatment tube 21 should preferably be made of stainless steel. The first treatment tube 21 of stainless steel has internal surfaces prevented from being corroded (oxidized) by fluorine and fluorine compound.

The first treatment tube 21 may be filled with two kinds of treating agents. If the first treatment tube 21 is filled with two kinds of treating agents, then the treating agents should preferably be positioned separately from each other so that they will not be mixed with each other for the purpose of preventing their treating capacities from being lowered. In this case, the first treatment tube 21 may have a mixture prevention net (not shown) or a porous partition plate (not shown) placed in the boundary between the treating agents.

The treating agent 22 in the first treatment tube 21 is gradually consumed with time as it adsorbs more fluorine, fluorine compound, and water. Accordingly, the treating agent 22 needs to be replaced a certain period of time after it has been used. For replacing the treating agent 22, the first treatment tube 21 is detached from the impurity removing apparatus 1. The first treatment tube 21 has an inlet valve 31 and an outlet valve 32 which are normally connected to the pipe 51. When the first treatment tube 21 is detached from the impurity removing apparatus 1, the inlet valve 31 and the outlet valve 32 are closed to prevent fluorine and fluorine compound from flowing out of the first treatment tube 21.

When the treating agent 22 removes fluorine and fluorine compound, it may produce water and oxygen as by-products according to the following reactions:

2F₂+2Ca(OH)₂→2CaF₂+2H₂O+O₂

2HF+Ca(OH)₂→CaF₂+2H₂O

SiF₄+2Ca(OH)₂→2CaF₂+SiO₂+2H₂O

However, the by-products such as water and oxygen are removed by the first treatment tube 21 and the second treatment tube 23 which will be described later.

The rare gas that has passed through the first treatment tube 21 is delivered to the second treatment tube 23. The second treatment tube 23 is filled with a metallic treating agent 24 which has been reduced in advance. Therefore, when the rare gas flows through the second treatment tube 23, the oxygen, which has been generated by the first treatment tube 21 and mixed with the rare gas, is removed by the metallic treating agent 24. Since the oxygen mixed as an impurity is removed from the rare gas, it is possible to make the rare gas reusable.

If the pipe 51 for circulating the rare gas therethrough has a temperature regulating means, such as a heating means, a cooling means, or the like, then it makes easy for the first treatment tube 21 and the second treatment tube 23 to remove fluorine, fluorine compound, and oxygen.

The metallic treating agent 24 should preferably comprise an Ni-based catalyst, a Cu-based catalyst, or a compound metal oxide.

If the metallic treating agent 24 comprises an Ni-based catalyst, then it removes oxygen from the rare gas according to the following reaction:

O₂+2Ni→2NiO

The first treatment tube 21 and the second treatment tube 23 may be constructed separately from each other or may be constructed as a single treatment device. If they are constructed separately from each other, then the metallic treating agent 24 in the second treatment tube 23 can individually be regenerated as described later. If they are constructed as a single treatment device, then the impurity removing apparatus 1 can be simpler in structure.

The second treatment tube 23 should preferably be made of stainless steel. The second treatment tube 23 of stainless steel has internal surfaces prevented from being corroded (oxidized) when a trace of fluorine and fluorine compound remains in the rare gas flowing through the second treatment tube 23.

Usually, treating agents are gradually consumed with time as they remove impurities. Therefore, the treating agents that have fully been consumed need to be replaced with new treating agents. However, the metallic treating agent 24 used in the second treatment tube 23 can be regenerated by a reductive reaction when a reducing gas such as H₂ is introduced into the metallic treating agent 24 while the metallic treating agent 24 is being heated at a temperature of 120° C. or higher.

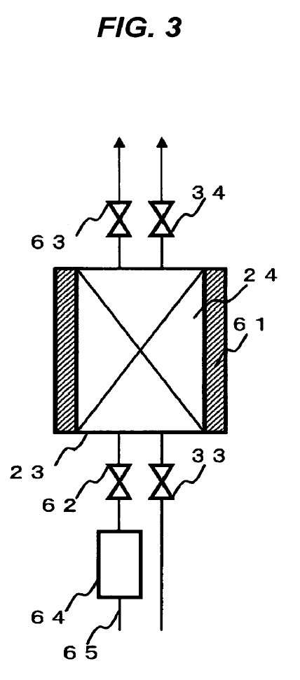

FIG. 3 shows in cross section the second treatment tube 23 which is provided with a regenerating device for regenerating the metallic treating agent 24 which fills the second treatment tube 23.

As shown in FIG. 3, the second treatment tube 23 has an inlet valve 33 and an outlet valve 34 which are normally connected to the pipe 51. The regenerating device includes a heater 61 disposed around the outer circumferential surface of the second treatment tube 23, a reducing gas inlet valve 62 connected to an inlet end of the second treatment tube 23, and a reducing gas outlet valve 63 connected to an outlet end of the second treatment tube 23.

The regenerating device regenerates the metallic treating agent 24 as follows: A reducing gas of H₂, for example, is introduced from a reducing gas supply line 65 through the reducing gas inlet valve 62 into the second treatment tube 23. At the same time, the second treatment tube 23 is heated by the heater 61 to reduce and regenerate the metallic treating agent 24 in the second treatment tube 23. The reducing gas should not be supplied to the excimer laser oscillation apparatus 10 because the reducing gas itself acts as an impurity in the excimer laser oscillation apparatus 10. While the metallic treating agent 24 in the second treatment tube 23 is being regenerated, therefore, the inlet valve 33 and the outlet valve 34 are closed, and the reducing gas inlet valve 62 is opened to introduce the reducing gas into the second treatment tube 23 and the reducing gas outlet valve 63 is opened to discharge the reducing gas from the second treatment tube 23.

Instead of the heater 61 provided on the second treatment tube 23, a heater 64 may be connected to the reducing gas supply line 65 for heating the reducing gas in the reducing gas supply line 65 to a predetermined temperature. When the heater 64 is energized, the reducing gas in the reducing gas supply line 65 is heated to the predetermined temperature and supplied through the reducing gas inlet valve 62 to the second treatment tube 23, thereby heating the metallic treating agent 24 to reduce and regenerate the metallic treating agent 24.

If the reduced metallic treating agent 24 is brought into contact with air, it will be oxidized. Therefore, the inlet valve 33 and the outlet valve 34 are closed to prevent the reduced metallic treating agent 24 from contacting air. When the second treatment tube 23, which is filled with the reduced metallic treating agent 24, is not in use, the inlet valve 33 and the outlet valve 34 are also closed to prevent the reduced metallic treating agent 24 from contacting air.

Returning to FIG. 1, the treating agents 22, 24 housed in the first and second treatment tubes 21, 23 tend to discharge particles as impurities when the impurity removing apparatus 1 is in operation. Therefore, the particles discharged from the treating agents 22, 24 need to be prevented from coming into below-described circulation pump 25 and the excimer laser oscillation apparatus 10. The particles refer to minute particles (powdery particles) included in the treating agents 22, 24 which have been formed to predetermined shape.

Therefore, the impurity removing apparatus 1 includes a metal filter 26 connected to the pipe 51 between the outlet valve 34 of the second treatment tube 23 and the circulation pump 25. The metal filter 26 serves to remove the particles discharged from the treating agents 22, 24. The metal filter 26 may be replaced with a non-metal filter such as a ceramic filter, a resin filter, or the like.

As shown in FIG. 1, the rare gas, which has passed through the metal filter 26, then flows into a circulation pump 25 as a circulating device. The circulation pump 25 operates to circulate the rare gas discharged from the excimer laser oscillation apparatus 10 through the pipe 51 of the impurity removing apparatus 1, and then returns the rare gas to the excimer laser oscillation apparatus 10. The circulation pump 25 should preferably have both a function to draw the rare gas and a function to compress the rare gas. The rare gas, which has been circulated through the pipe 51 by the circulation pump 25 with such dual functions, can flow back to the excimer laser oscillation apparatus 10 without remaining in the pipe 51 of the impurity removing apparatus 1.

The circulation pump 25 should preferably be positioned downstream of the first treatment tube 21. By thus positioning the circulation pump 25, internal surfaces of the circulation pump 25 can be prevented from being oxidized by fluorine and fluorine compound mixed with the rare gas thereby producing contaminants. The circulation pump 25 may be positioned immediately downstream of the first treatment tube 21 or downstream of the second treatment tube 23 insofar as fluorine and fluorine compound contained in the rare gas have already been removed before the rare gas goes into the circulation pump 25.

The circulation pump 25 includes therein metal parts such as valves, bearings, and others which frictionally contact each other. Therefore, the circulation pump 25 may produce metal particles which flow into the pipe 51. Therefore, the impurity removing apparatus 1 also includes a metal filter 27 connected to the pipe 51 downstream of the circulation pump 25 for removing the metal particles from the rare gas and hence preventing them from leaving the impurity removing apparatus 1 and entering the excimer laser oscillation apparatus 10, as shown in FIG. 1. The metal filter 27 may be replaced with a non-metal filter such as a ceramic filter, a resin filter, or the like.

The metal filters 26, 27, which trap particles, are connected downstream of the second treatment tube 23 and the circulation pump 25, respectively, as shown in FIG. 1. As the amount of particles trapped by the metal filters 26, 27 increases, it causes the pressure loss in the pipe 51 to increase. The pressure in the pipe 51 may be detected by a pressure sensor 28. The pressure sensor 28 may be positioned anywhere on the line 51, e.g., downstream of the second treatment tube 23 or downstream of the circulation pump 25. However, the pressure sensor 28 should preferably be located on a portion of the pipe 51 which extends between the second treatment tube 23 and the metal filter 26 where the pressure loss tends to increase the most.

In FIG. 1, the pipe 51 includes a pipe 51a through which the rare gas discharged from the excimer laser oscillation apparatus 10 flows into the impurity removing apparatus 1, and a pipe 51b through which the rare gas discharged from the impurity removing apparatus 1 flows into the excimer laser oscillation apparatus 10. The pipes 51a, 51b will also be referred to as the pipe 51 if they do not need to distinguish from each other.

The circulation flow inlet 41 of the impurity removing apparatus 1 is provided with an inlet valve 35, and the circulation flow outlet 42 of the impurity removing apparatus 1 is provided with an outlet valve 36. When the inlet valve 35 and the outlet valve 36 are closed, the pipe 51 between the excimer laser oscillation apparatus 10 and the impurity removing apparatus 1 is cut off. Therefore, except when the impurities contained in the rare gas discharged from the excimer laser oscillation apparatus 10 are to be removed by the impurity removing apparatus 1, any impurities are prevented from flowing from the impurity removing apparatus 1 into the excimer laser oscillation apparatus 10 by closing the inlet valve 35 and the outlet valve 36.

The impurity removing apparatus 1 may also include a bypass line 52 for providing a bypass path between the circulation flow inlet 41 and the circulation flow outlet 42 and a bypass valve 37 connected to the bypass line 52. The bypass line 52 interconnects the circulation flow inlet 41 downstream of the inlet valve 35 and the circulation flow outlet 42 upstream of the outlet valve 36, as shown in FIG. 1. When the inlet valve 35 and the outlet valve 36 are closed and the bypass valve 37 is opened, the rare gas that has been introduced into the impurity removing apparatus 1 circulates in the impurity removing apparatus 1. When the rare gas circulates in the impurity removing apparatus 1 in this manner, the impurities contained in the rare gas can be removed to an increased level of accuracy. If the impurities contained in the rare gas discharged from the excimer laser oscillation apparatus 10 cannot be fully removed in one cycle of operation of the impurity removing apparatus 1, i.e., while the rare gas flows only once through the line 51, then the inlet valve 35 and the outlet valve 36 are closed and the bypass valve 37 is opened, causing the rare gas to circulate twice or more through the line 51 to remove the impurities more effectively therefrom.

When the treating agent 22 housed in the first treatment tube 21 is to be replaced, the first treatment tube 21 is detached from the impurity removing apparatus 1. When the first treatment tube 21 is detached from the impurity removing apparatus 1, connection ports of the pipe 51, which have been connected to the first treatment tube 21, are brought into contact with the atmospheric air. Therefore, impurities such as the atmospheric air are likely to enter the pipe 51. To purge the impurities such as the atmospheric air which have been introduced into the pipe 51, a purge gas inlet line 43 may be connected to the circulation flow inlet 41 downstream of the inlet valve 35, and a purge gas outlet line 44 connected to a vacuum pump, not shown, may be connected to the circulation flow outlet 42 upstream of the outlet valve 36. To purge the impurities out of the pipe 51, the inlet valve 33 and the outlet valve 34 are closed, thereby cutting off the pipe 51 between the excimer laser oscillation apparatus 10 and the impurity removing apparatus 1. Then, a purge gas is introduced via the purge gas inlet line 43 into the pipe 51 and discharged from the pipe 51 via the purge gas outlet line 44 by the vacuum pump. This can introduce the purge gas into the pipe and discharge the purge gas from the pipe 51 by the vacuum pump while preventing the impurities such as the atmospheric air from coming into the excimer laser oscillation apparatus 10.

The purge gas inlet line 43 and the purge gas outlet line 44 connected to the vacuum pump may be connected to an upstream side of the inlet valve 35 and a downstream side of the outlet valve 36, respectively. If the excimer laser oscillation apparatus 10 and the impurity removing apparatus 1 are spaced from each other, then the pipe 51 which extends therebetween may be evacuated or purged by the purge gas inlet line 43 and the purge gas outlet line 44 thus connected.

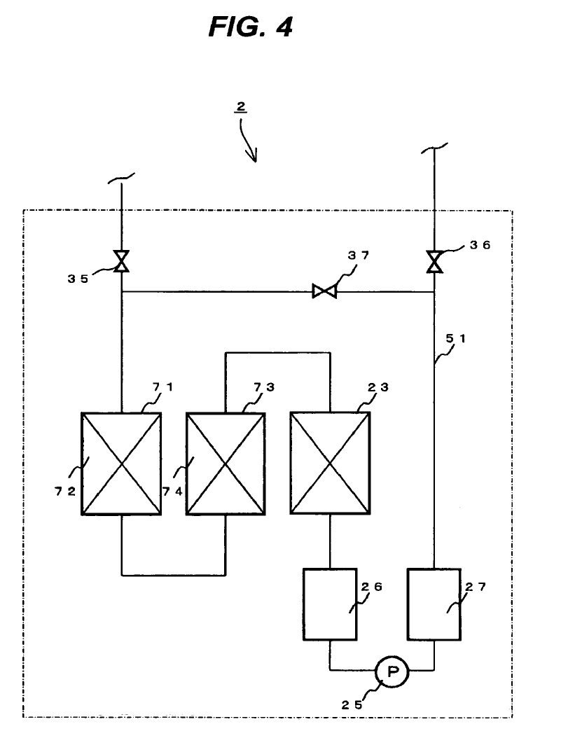

FIG. 4 shows in block form an impurity removing apparatus 2 according to a second embodiment of the present invention. The impurity removing apparatus 2 serves to remove impurities such as SF₆, CF₄, C₂F₆, etc. (hereinafter referred to as “PFC gas”), in addition to fluorine, water and oxygen, contained in the rare gas discharged from the excimer laser oscillation apparatus 10. The impurity removing apparatus 2 includes a third treatment tube (treatment device) 71 filled with a treating agent 72 for removing the PFC gas from the rare gas.

The PFC gas cannot be removed from the rare gas at the normal temperature. The treating agent 72 housed in the third treatment tube 71 comprises a catalyst which is heated to a temperature of 700° C. or higher. The impurity removing apparatus 2 also includes a fourth treatment tube (treatment device) 73 filled with a treating agent 74 for removing water from the rare gas. The fourth treatment tube 73 is connected downstream of the third treatment tube 71. If no water is contained in the rare gas, then fourth treatment tube 73 is not required.

When the PFC gas is removed from the rare gas by the third treatment tube 71, SOₓ and CO₂ may be generated depending on the treating agent 72 used. Therefore, the fourth treatment tube 73 may comprise a treatment tube for removing SOₓ and CO₂ generated by the third treatment tube 71. The impurity removing apparatus 2 also includes the second treatment tube 23 shown in FIG. 1 downstream of the fourth treatment tube 73 to remove oxygen from the rare gas.

As shown in FIG. 4, the impurity removing apparatus 2 according to the second embodiment of the present invention is similar to the impurity removing apparatus 1 according to the first embodiment except that the first treatment tube 21 is replaced with the third treatment tube 71 and the fourth treatment tube 73.

An impurity removing apparatus according to a third embodiment of the present invention will be described below. The impurity removing apparatus according to the third embodiment is the same as the impurity removing apparatus 1 according to the first embodiment or the impurity removing apparatus 2 according to the second embodiment, but is connected to a plurality of excimer laser oscillation apparatus 10 shown in FIG. 1. Specifically, the pipes connected to the plural excimer laser oscillation apparatus are combined into respective single pipes that are connected to the impurity removing apparatus 1 or 2. According to the third embodiment of the present invention, therefore, the impurity removing apparatus 1 or 2 can effectively be utilized while fluorine, fluorine compound, oxygen, and, if necessary, water and PFC gas are effectively removed from the rare gas discharged from the plural excimer laser oscillation apparatus. It is also possible to remove the impurities from the rare gas discharged from those of the plural excimer laser oscillation apparatus which are in operation.

The impurity removing apparatus according to the present invention removes fluorine that contributes as a component of the laser gas. In order to make up for the removed fluorine, an inlet pipe for adding fluorine may be connected to the line 51 in the impurity removing apparatus according to the first through third embodiments. The inlet pipe should preferably be connected to the line 51 downstream of a region where the impurities are removed from the rare gas and upstream of a region where the rare gas is returned to the excimer laser oscillation apparatus.

### EXAMPLE

An impurity removal performance test was carried out by using the impurity removing apparatus 1 according to the first embodiment of the present invention. The results are shown in Table below. In the test, a rare gas containing impurities was introduced into the impurity removing apparatus 1 at a rate of 10 l/min. In the Table, “ppm” represents a volume percentage concentration.

TABLE

| | CONCENTRATION | | CONCENTRATION |
|---|---|---|---|
| IMPURITIES | BEFORE TREATMENT | | AFTER TREATMENT |
| F₂ | 5000 | ppm | 0.5 ppm or less |
| H₂O | 50 | ppm | 1.0 ppm or less |
| O₂ | 50 | ppm | 1.0 ppm or less |
| HF | 1000 | ppm | 0.5 ppm or less |

The rare gas used in the impurity removal performance test was an Ne gas. A combination of zeolite and calcium hydrate was used as a treating agent for removing fluorine (F₂), hydrogen fluoride (HF), and water (H₂O), and a Cu-based treating agent was used for removing oxygen (O₂).

The impurity removing apparatus according to the embodiments of the present invention allow the rare gas discharged from the excimer laser oscillation apparatus, particularly the buffer gas which makes up most of the rare gas, to be reused. Most of the rare gas discharged from the excimer laser oscillation apparatus comprises a rare gas which is used as the buffer gas. The buffer gas may comprise helium or neon, or may comprise another rare gas. For example, the laser tube of an excimer laser oscillation apparatus is usually filled with about 95-95% of neon gas, about 1-5% of krypton gas, and about 0.1-0.5% of fluorine gas. Since these rare gases are expensive, the rare gas, which makes up 95-95% of the laser gas, can effectively be utilized if it is reused, and the running cost of the rare gases is effectively reduced.

The impurity removing apparatus according to the embodiments of the present invention can remove the impurities from the rare gas circulating therein even when the excimer laser oscillation apparatus is in operation, e.g., even when the excimer laser oscillation apparatus is emitting a laser beam. The fluorine gas contained in the rare gas is of about 0.1-0.5%, and generates a fluorine compound. The generated fluorine compound serves as an impurity in the rare gas. The impurity removing apparatus according to the embodiments of the present invention remove fluorine and fluorine compound from the rare gas while the rare gas is circulating in the impurity removing apparatus at all times when the impurity removing apparatus is in operation. The impurity removing apparatus can remove impurities such as fluorine compound with increased removal efficiency to allow the rare gas to be reused. As a result, the rare gas, which is scarce and expensive, can be reused, and the excimer laser oscillation apparatus combined with the impurity removing apparatus can utilize the rare gas effectively.

Although certain preferred embodiments of the present invention have been shown and described in detail, it should be understood that various changes and modifications may be made therein without departing from the scope of the appended claims.

What is claimed is:

1. An impurity removing apparatus comprising:
a first treatment device for removing fluorine and fluorine compound which are mixed with a rare gas discharged from an excimer laser oscillation apparatus;
a second treatment device for removing oxygen generated by the first treatment device; and
a circulation device for circulating the rare gas discharged from the excimer laser oscillation apparatus and returning the rare gas to the excimer laser oscillation apparatus.

2. An impurity removing apparatus according to claim 1, wherein the circulation device circulates the rare gas from the excimer laser oscillation apparatus to the first treatment device, then from the first treatment device to the second treatment device, and then from the second treatment device to the excimer laser oscillation apparatus.

3. An impurity removing apparatus according to claim 1, wherein the second treatment device is configured to remove the oxygen with a treating agent, and is provided with a regenerating device for regenerating the treating agent to make the treating agent reusable after the treating agent has been used to remove the oxygen.

4. An impurity removing apparatus according to claim 1, wherein the first treatment device comprises a device for removing fluorine and fluorine compound, and water or a PFC gas which are mixed with the rare gas.

5. An impurity removing apparatus according to claim 1, wherein the impurity removing apparatus removes fluorine and fluorine compound which are contained in rare gases discharged from a plurality of excimer laser oscillation apparatus, and removes oxygen which is generated when the fluorine and the fluorine compound are removed.

6. A method of operating an impurity removing apparatus, comprising:
circulating a rare gas discharged from an excimer laser oscillation apparatus which emits a laser beam;
removing fluorine and fluorine compound which are mixed with the rare gas;
removing oxygen which is generated when the fluorine and the fluorine compound are removed;
returning the rare gas to the excimer laser oscillation apparatus; and
reusing the rare gas returned to the excimer laser oscillation apparatus.
